(19) United States
(12) Patent Application Publication
(10) Pub. No.: US 2003/0007420 A1
(43) Pub. Date: Jan. 9, 2003

(54) Dial face of watch graphically represents calendar

(75) Inventor: Yevgeniy Eugene Shteyn, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/900,375

(22) Filed: Jul. 5, 2001

(51) Int. Cl. G04B 47/00; G04C 17/00; G04B 19/00; G04B 25/00

(52) U.S. Cl. 368/10

(57) ABSTRACT

An electronic device has a timepiece with a dial face. The dial face comprises a display monitor for providing a graphical representation of a scheduled event. The representation comprises a segment whose length is associated with the duration of the event and whose graphical attributes correspond with a type of the scheduled event as specified by the user in advance. The device is, for example, a watch that communicates with the user's PDA through a Bluetooth link in the user's Personal Area Network (PAN).

### FIELD OF HE INVENTION

The invention generally relates to an electronic device with a graphical user interface (GUI). More particularly the invention relates to a timepiece, e.g., a watch, that has a GUI for providing information in addition to the time of the day.

### BACKGROUND ART

A timepiece typically has a dial face and hands whose relative positions with respect to the face and with respect to each other indicate the time in terms of hours, minutes and seconds. An advantage of such a timepiece with an analog GUI over a clock with an alphanumeric representation is that the user does not have to actually read the alphanumeric characters, one after the other, and interpret them. The relative positions of the hands form an image that is much easier to process.

### SUMMARY OF THE INVENTION

The inventor proposes to use the dial face of the timepiece, e.g., a watch, as part of a GUI that is programmable to indicate specific time slots allocated to the user's personal scheduled activities as have been entered into the user's personal calendar. For example, the dial face comprises a display monitor such as an LCD or an LED-based display, that form segments whose appearance is programmable. Circle segments running along the perimeter of the dial face may take on different colors and different lengths that indicate to the user the types of activity scheduled, hereafter referred to as activity layers, and the lengths of the time slot allocated. The activity layers may also represent schedules of other people, e.g., spouse, other family members, friends or co-workers, or may refer to the broadcast time of regular TV programs, etc. The user is preferably enabled to switch between different activity layers or combine a number of those in order to reconcile his/her schedule with other events. In an embodiment of the invention, the timepiece communicates with the electronic calendar in the user's PDA through a short range communication protocol, e.g., using Bluetooth, in order to update the activity schedule downloaded to the time piece. In another embodiment of the invention, the timepiece communicates with a mobile phone over a personal area network (PAN). The timepiece can be set up to automatically update the representation of scheduled activities as soon as the information is available within the PAN. In yet another embodiment of the invention, the timepiece communicates with another timepiece, e.g., via a PAN bridge, to obtain one or more activity layers from another person or another source. This allows to determine, e.g., time slots available for a meeting or if the user has to re-schedule activities previously entered. The user may keep the time slot representation of the other person's activity as a part of the user's graphical schedule representation.

Within this context, the following patent documents are incorporated herein by reference:

U.S. Ser. No. 09/464,866 (attorney docket PHA 23,884) filed Dec. 16, 1999 for Rik Sagar for SHARED ADDRESS-DATA SERVICE FOR PERSONAL CE EQUIPMENT. This document relates to enabling the user to upload, to a server on the Internet, information from a first contact database in a first communications apparatus. The server manipulates the uploaded information and extracts or converts the format of the records for a second contact data base of a second communications apparatus.

U.S. Ser. No. 09/802,618 (attorney docket US 018028) filed Mar. 8, 2001 for Eugene Shteyn for ACTIVITY SCHEDULE CONTROLS PERSONALIZED ELECTRONIC CONTENT GUIDE. This document relates to determining electronic content information and the time slots for play-out based on the activities scheduled in the user's electronic calendar and the user's profile or declared interests. In this manner, the recording and downloading of content is automated based on the user's life style.

U.S. Ser. No. 09/823,141 (attorney docket US 018043) filed Mar. 30, 2001 for Eugene Shteyn for TASK MANAGEMENT SYSTEM. This document relates to a system for creating and deleting reminders to perform a task, which requires the movement of an object from a first location to a second location. An indicator is attached to the object, a first sensor is mounted adjacent the first location for detecting the indicator and outputting a signal in response thereto. A second sensor is mounted adjacent the second location for detecting the indicator and outputting a signal in response thereto. A monitor includes a program, which generates a reminder to perform the task in response to a signal from the first sensor, and cancels the reminder in response to a signal from the second sensor.

U.S. Ser. No. 09/635,548 (attorney docket US 000107) filed Aug. 10, 2000 for Eugene Shteyn and Paul Rankin on MOBILE MICRO PORTAL. This document relates to a geographic region with a network of beacons. Each beacon transmits a short-range facilitation signal, e.g., using Bluetooth, for receipt on a user's mobile communication device. The facilitation signal initiates associating the facilitation signal with a service and conditionally alerts the user to the service via the device dependent on a user profile. The user-profile and the association between facilitation signal and service are user-programmable.

### BRIEF DESCRIPTION OF THE DRAWING

The invention is explained below in further detail, by way of example, and with reference to the accompanying drawing wherein:

FIG. 1 is a diagram of a dial face of a timepiece; and

FIGS. 2 and 3 are block diagrams of a system in the invention.

Throughout the drawing, same reference numerals indicate similar or corresponding features

### DETAILED EMBODIMENTS

A watch is a very common ornament worn by the user almost permanently. The proximity of the watch to the user is therefore a good reason for using the watch as a user-interface to information that has some relationship with temporal aspects. In the invention, the dial face is programmable to indicate time slots allocated to the user's personal scheduled activities. These activities have been entered into the user's personal calendar (e.g., on a PC or PDA) and get downloaded to the watch, or they have been programmed into the watch, e.g., through a suitable menu with pre-programmed options such as type of event, contemplated begin and end, etc. The time slots are indicated, e.g., by circle segments of different colors or textures for different types of activities, and of lengths (arc lengths) that indicate the duration of the individual time slots. The watch could be communicating with the calendar in the user's PDA or cell phone through Bluetooth to obtain the data representative of the begin and end of the time slot as well as of the type of activity. A PDA or cell phone gets used increasingly more and has obtained the status of a personal trusted device. The watch's dial face is used as an intuitive GUI to the information stored at the PDA, or stored at or transferred via the cell phone.

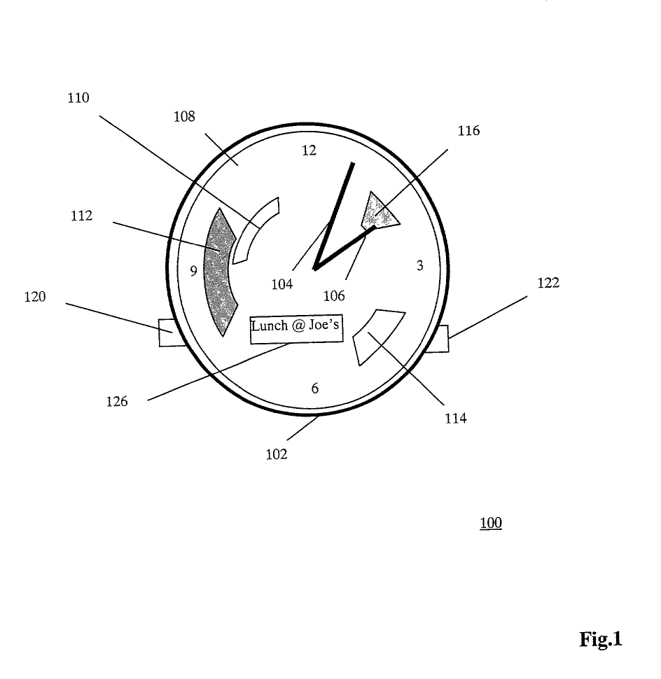

FIG. 1 is a diagram of a dial face 102 of a timepiece 100 that indicates the time of the day in an analog manner using hands 104 and 106. Dial face 102 comprises a display monitor 108, e.g., an LCD. Other types of display monitors, e.g., LED-based, LCOS (Liquid Crystal on Silicon), etc., may be suitable as well. Monitor 108 is programmable so as to graphically indicate time slots. In the example shown, monitor 108 indicates time slots 110, 112, 114 and 116 as circle segments. Each segment 110-116 covers a certain arc and is located at a certain position. The length of the arc indicates the length of the relevant time slot when radially projected onto the perimeter. For example, segment 114 covers the time period from 4 o'clock to 5 o'clock, its being positioned in the lower right quadrant between the hour indications “3” and “6”. In the example shown, segments 110 and 112 are located at different radii, and their projections overlap. Depending on the implementation, this could indicate to the user that the corresponding activities are conflicting at least partly. Alternatively, segment 112 indicates an activity scheduled in the first 12 hours of the day (e.g., before noon or “a.m.”), and segment 110 indicates an activity in the second 12 hours of the day (e.g., in the afternoon or “p.m.”). Segments 110, 112 and 116 have different colors or shading, indicating different types of activities: segment 110 indicates, for example, a doctor's appointment, segment 110 a business meeting and segment 116 a table tennis game before resuming work. Segment 114 and segment 110 have the same color and both indicate work relates activities. Preferably, the user is enabled to pre scribe or program the color or shading to distinguish between types of scheduled activities. Conflicting or partly overlapping time slots could be indicated with segments at the same radii, the overlap having a color or hatching different from the rest. Button 120 is provided to navigate between different activity layers. Button 122 is provided to navigate between different segments of an activity layer and if necessary to delete an activity. Optional information window 126 may display information related to current activity, activity selected with button 122, activity layer selected with button 120, etc. Alternatively, an interface to activity selection and a navigation system can be implemented using voice recognition technology. In such an embodiment a limited set of navigation and selection commands, e.g. as “next”, “previous”, “OK”, etc., words related to temporal aspects, such as “hours”, “minutes”, “days”, “month”, etc, are expected and recognized by the system. The voice recognition and interpretation can be performed by another device, e.g., a mobile phone, connected with timepiece 100 via the PAN.

In an embodiment, segments appear at smaller radii if they represent activities farther away in the near future, and at larger radii if the scheduled activity is closer within the near future. The segments can be programmable to automatically disappear after the time of the contemplated end of the activity has passed.

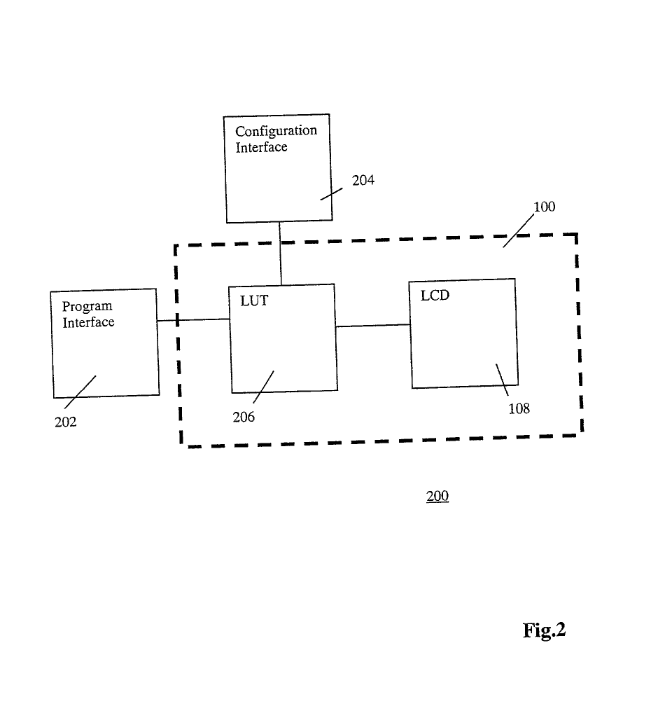

FIG. 2 is a block diagram of a system 200 in the invention. System 200 comprises timepiece 100 with LCD 108, a program interface 202, a configuration interface 204 and a look-up table (LUT) 206. Program interface enables the user to enter data into timepiece 100 for operational use. For example, the data entered through interface 202 specifies the begin moment of a specific activity scheduled, the end moment of the activity scheduled and the type of the activity. This data could be entered manually at timepiece 100 (e.g., drop down menu's with scroll bars to select begin, end and type); or could be entered from another electronic device, e.g., the user's PDA (not shown). Configuration interface 204 enables the user to program LUT 206, e.g., with regard to the color or shading of the graphical representation per type of activity. The configuration interface may have a software counterpart at a PC or PDA so as to keep timepiece 100 lean. In order to simplify timepiece 100 further, a graphical representation of an activity layer can be produced by another electronic device and loaded into timepiece 100 as a graphic background. In the latter embodiment, LUT 206 may reside on the aforementioned electronic device or on the network (not shown).

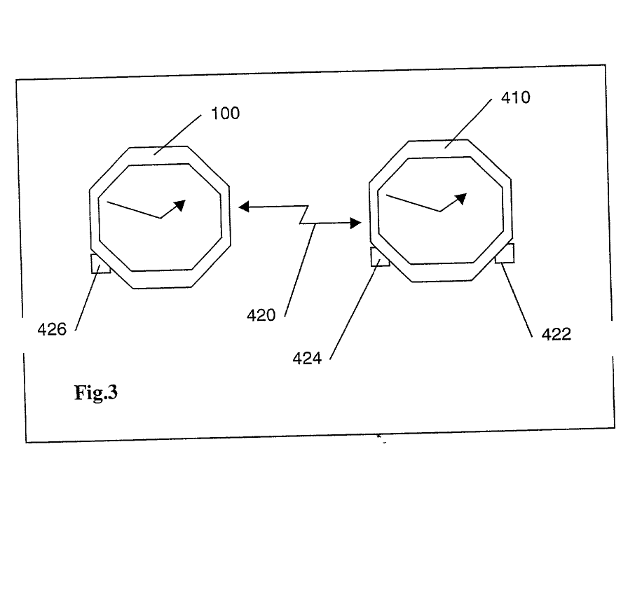

FIG. 3 is a block diagram of a system 400 in the invention. System 400 comprises timepiece 100 and timepiece 420 that are enabled to communicate with each other via signal 420. Signal 420 can be transmitted wirelessly, e.g. using a Bluetooth protocol, or via a wire (not shown), using a proprietary serial interface. Button 422 is used to select an activity or an activity layer. Buttons 424 and 426 are used respectively to send and receive communication signal 420.

The invention can be implemented as a watch or a stationary timepiece on the desk of the user, or as a clock in the dashboard of the user's car, etc. An aspect of the invention can also be implemented in software. Accordingly, the invention also relates to software for rendering a dial face of a timepiece on a display monitor. The software enables to render a graphical representation of a scheduled activity on the dial face. The location of the representation on the dial face corresponds to a time slot associated with the scheduled activity. For example, the software controls a graphical representation of an analog clock, its dial face and its hands. The segments are positioned such that their location is intuitively associated with a certain time slot, e.g., as an icon or circle segment covering a certain angle between two positions on the perimeter of the dial face as shown in FIG. 1. The angle represents one or more hours, or portions thereof. Such a software representation is rendered, e.g., on the screen of a PDA or PC, or as a screen-saver, etc.

The invention can be used as in the following example. Consider the example of a household wherein both man and wife have daytime jobs. Both have a watch of the type described above, capable of graphically representing scheduled activities in an intuitive manner on the dial face. Each of the spouses has a PAN comprising a communication device, such as a cell phone. The cell phone and watch communicate within the PAN using a short-range data communication protocol, e.g., Bluetooth. The cell phone has software onboard to communicate information about activities, newly scheduled by the user, to the cell phone of the other user. From the receiving cell phone, the data gets communicated to the latter user's watch and rendered. The communication between the phones is preferably a background process that does not require any user-intervention. In this manner, both users are being kept informed, at least graphically, about each other's schedule.

What is claimed is:

1. An electronic device with a timepiece having a dial face that comprises a display monitor for providing a graphical representation of a scheduled activity.

2. The device of claim 1, wherein the representation comprising a segment whose length is associated with the duration of the activity.

3. The device of claim 2, wherein the segment has a graphical attribute associated with a type of the scheduled activity.

4. The device of claim 2, wherein a location of the representation is representative of a begin time of the activity.

5. The device of claim 1, wherein the graphical representation is programmable.

6. The device of claim 2, wherein the segment is located along a perimeter of the dial face.

7. The device of claim 1, wherein the device is capable of providing at least a further graphical representation of a further scheduled activity.

8. The device of claim 1, comprising a communication component for communicating with another electronic device.

9. The device of claim 8, wherein the communication uses a short range communication protocol.

10. The device of claim 9, wherein the other electronic device comprises an electronic calendar.

11. The device of claim 9, wherein the other electronic device comprises a mobile phone.

12. A method of enabling an electronic device to be programmed, the device having a time piece with a dial face that comprises a display monitor for providing a graphical representation of a scheduled activity, the method comprising communicating data to the device for control of the representation.

13. Software for rendering a dial face of a timepiece on a display monitor, the application enabling to render a graphical representation of a scheduled activity on the dial face, a location of the representation on the dial face corresponding to a time slot associated with the scheduled activity.
